(19) United States
(12) Patent Application Publication
(10) Pub. No.: US 2024/0282953 A1
(43) Pub. Date: Aug. 22, 2024

(54) POSITIVE ELECTRODE ACTIVE MATERIAL FOR LITHIUM SECONDARY BATTERY

(71) Applicant: L&F CO., LTD., Daegu (KR)

(72) Inventors: Hyun Gyu HAN, Daegu (KR); Sung Kyun CHANG, Daegu (KR); Hwa Young SON, Daegu (KR); Jae Joon JO, Daegu (KR); Han Ah KIM, Daegu (KR); Gi Hwan CHANG, Daegu (KR)

(21) Appl. No.: 18/563,984

(22) PCT Filed: May 27, 2022
(86) PCT No.: PCT/KR2022/007601

§ 371 Date: Jan. 23, 2024

(30) Foreign Application Priority Data
Jun. 18, 2021 (KR) 10-2021-0079572

(51) Int. Cl. H01M 4/525; H01M 4/02; H01M 4/505; H01M 10/052

(52) U.S. Cl. CPC H01M 4/525; H01M 4/505; H01M 10/052; H01M 2004/021; H01M 2004/028

(57) ABSTRACT

Disclosed is a cathode active material for a lithium secondary battery comprising one-body primary particles of lithium transition metal complex oxide and having a cumulative relative particle amount (%) of particles having a particle size of 1.5 μm or less, which is 25% or less of a total amount of particles in a particle size distribution (PSD) graph (X-axis: particle size (μm), Y-axis: relative particle amount (%)).

### TECHNICAL FIELD

The present invention relates to a cathode active material and more particularly, to a cathode active material that contains one-body primary particles, has uniform particle distribution, and exhibits improved secondary battery characteristics such as improved lifespan characteristics and reduced resistance by controlling the generation of fine powders.

### BACKGROUND ART

Lithium secondary batteries are mainly used for digital devices such as laptops and mobile phones and lithium secondary batteries are finding ever expanding applications from portable information and communication devices to electric vehicles, hybrid automobiles, aerospace, and energy storage systems (ESS) based on cost reduction and performance stabilization through mass production and technological development and the market for lithium secondary batteries is expected to continue to grow.

The core materials of lithium secondary batteries are a cathode active material, an anode active material, an electrolyte, and a separator. Thereamong, the cathode active material is the most important for manufacturing secondary batteries and is divided into lithium cobalt oxide (LCO), lithium nickel cobalt manganese oxide (NCM), lithium nickel cobalt aluminum oxide (NCA), lithium manganese oxide (LMO), lithium iron phosphate (LFP), and the like, depending on constituent materials thereof.

Conventional cathode active materials are mainly used in the form of secondary particles in which primary particles aggregate. The cathode active material in the form of secondary particles has a high specific surface area, thus causing an increase in a direct contact area with an electrolyte solution and side reactions with the electrolyte solution.

In addition, the presence of secondary particles in the cathode active material reduces the initial discharge capacity due to increased internal impedance of batteries and causes destruction of particles due to stress formed at the grain boundary surface upon stretching and contraction of the crystal lattice during charging and discharging. Eventually, this may cause deterioration of lithium secondary battery capacity.

Therefore, one-body cathode active materials in which primary particles are monodispersed without forming secondary aggregates may be advantageous for improving battery characteristics and, for this reason, research is actively underway on one-body active materials, which are primary particles with a one-body structure.

Such a one-body active material is in the form of a single particle and thus has less possibility of destruction, i.e., cracking, and reduces side reactions due to a small specific surface area in contact with an electrolyte solution compared to secondary particles.

On the other hand, active materials having a one-body structure may cause aggregation of multiple active materials during firing for manufacturing, which results in uneven particle size distribution, causing problems such as decreased lifespan characteristics and increased resistance.

As a method for solving the problem of non-uniform particle size of the active material, a separate post-treatment process such as grinding after firing may be introduced, which enables uniform particle distribution of the active material.

However, the post-treatment process may cause a deterioration in the characteristics of the battery. For example, a uniform particle size distribution of the active material is possible, but fine powders may increase due to excessive post-treatment and this increase in fine powders may have negative effects on characteristics, resistance characteristics, and the like.

Therefore, uniform particle size distribution and appropriate control of fine powder generation are required in order to optimize the characteristics of one-body active materials with the goal of improving battery characteristics, such as reducing resistance.

### DISCLOSURE

### Technical Problem

Therefore, the present invention has been made to solve the above and other technical problems that have yet to be solved.

After repeated extensive research and various experiments, the present inventors found that, when a cumulative relative particle amount of particles having a particle size below a predetermined size in a particle size distribution (PSD) graph is controlled below a predetermined range, the properties of an active material having a circular body shape can be optimized by preventing an increase in fine powders without adversely affecting lifespan characteristics and resistance characteristics, as will be described below, and the present invention was completed based thereon.

### Technical Solution

In accordance with an aspect of the present invention, provided is a cathode active material for a lithium secondary battery including one-body primary particles of lithium transition metal complex oxide, and having a cumulative relative particle amount (%) of particles having a particle size of 1.5 μm or less, which is 25% or less of the total amount of particles in a particle size distribution (PSD) graph (X-axis: particle size (μm), Y-axis: relative particle amount (%)).

It is necessary to solve the problem of particle size distribution non-uniformity caused during the firing process of a cathode active material containing one-body primary particles, that is, a cathode active material having a one-body shape, but the problem of increased fine particles may result. An appropriate amount of fine powder may contribute to the improvement of initial capacity of secondary batteries, but a fine powder over a predetermined amount may have a negative effect on lifespan characteristics, resistance characteristics, or the like.

Therefore, conditions are required to suppress the generation of excessive fine powder while solving the problem of non-uniform particle size distribution in a cathode active material containing one-body primary particles.

It is generally considered that, as the content of a cathode active material with a relatively small particle size increases, the possibility of presence of fine powder therein also increases. The present inventors found that, as defined above, the problem of non-uniform particle size distribution can be solved and the occurrence of excessive fine powder can be suppressed when a cumulative relative particle amount (%) of particles having a particle size of 1.5 μm or less is 25% or less of the total amount of particles in a particle size distribution (PSD) graph.

Here, the particle size distribution (PSD) graph can be obtained, for example, under the following particle size distribution (PSD) measurement conditions.

### Measurement Conditions

Measuring equipment: Microtrac S3500 Extended
Circulation speed: 45%/see
Refractive index ratio: 1.55
Solvent fed to equipment: distilled water
Sample of cell: 0665
Calculation Logic: X100
Sample amount: 0.0025 g
Dispersant added to sample: 10% sodium hexametaphosphate 1 ml
Solvent added to sample: 40 ml distilled water
Sample ultrasonic dispersion: 40 kHz, 1 min

The requirements for the content of particles of such a specific particle size can be determined, for example, through a post-treatment process of applying force such as pressure or shear force to active material particles after firing for preparing a cathode active material.

Specifically, a post-treatment process of applying force to the particles may be performed under the condition that a cumulative relative particle amount (%) of particles having a particle size of 1.5 μm or less is 25% or less of the total amount of particles in a particle size distribution (PSD) graph.

In a specific embodiment, the applied force may be in the range of 0.05 MPa to 0.25 MPa, preferably in the range of 0.1 MPa to 0.2 MPa.

The lower limit of the content of particles having a particle size of 1.5 μm or less is not particularly limited and is preferably as low as possible, and may be substantially in the range of 1% or more due to the nature of the post-treatment process of applying force.

In a specific embodiment, the ratio of the cumulative relative particle amount (%) of particles having a size of 1.5 μm or less to the relative particle amount (%) of D₅₀ (cumulative relative particle amount of 1.5 μm or less/relative particle amount of D₅₀) in the particle size distribution (PSD) analysis may be 0.5 or less, preferably in the range of 0.01 to 0.4. When the ratio exceeds out of the range, there may be a high possibility that the cathode active material will contain an excessive amount of fine powder.

The content of fine powder in the cathode active material may also be estimated through the particle size of Dmin. Of course, fine powders with a particle size below a certain level may not be detected through the particle size distribution (PSD) analysis. However, as the Dmin, which indicates the minimum particle size that can be detected in the particle size distribution (PSD) analysis decreases, there may be a high possibility that particles fall within the fine powder range. This may be considered that there is a high possibility of the presence of particles falling within the fine powder range that cannot be detected even through particle size distribution (PSD) analysis due to the particle size lower than Dmin.

Therefore, in a specific embodiment, the cathode active material for a lithium secondary battery according to the present invention may have a Dmin of 0.9 μm or more, preferably 1.0 μm or more in particle size distribution (PSD) analysis. From a technical perspective, there is no need to specifically set the upper limit of Dmin.

The lifespan characteristics and resistance increase of a battery are also related to the size uniformity of particles constituting the active material, and the uniformity of the particle size can act as a key factor in improving the characteristics of the battery. Therefore, the cathode active material according to the present invention is characterized by reducing the generation of fine powder and having a uniform particle size distribution.

In this regard, in a specific embodiment, the cathode active material of the present invention has a ratio of a full width at half-maximum (FWHM) of a main peak to a maximum height (FWHM/maximum height) of 1.0 or less in a particle size distribution (PSD) graph.

One of the factors affecting the performance of lithium secondary batteries, such as improved lifespan and efficiency, is a uniform particle size distribution of the active material. As the width of the main peak in the graph that can be obtained through PSD decreases, the uniformity of the particle size distribution of the active material increases. This may be determined by measuring the FWHM of the main peak.

Accordingly, the cathode active material of the present invention has more uniform particle size distribution when the value obtained by dividing the FWHM of the main peak by the maximum height thereof in the PSD graph satisfies the range defined above.

The lower limit of the FWHM/maximum height is not particularly limited and may be, for example, 0.2 or more.

The uniformity of the particle size distribution can be determined by detecting the particle size distribution expressed as (D₉₀-D₁₀)/D₅₀, in addition to measuring the half-width value of the maximum peak on the particle size distribution graph. As (D₉₀-D₁₀)/D₅₀ decreases, the uniformity of particle size distribution increases.

Accordingly, in another specific embodiment, the cathode active material of the present invention may have a particle size distribution expressed as (D₉₀-D₁₀)/D₅₀ in the range of 1.2 or less, preferably in the range of 1.0 or less.

The lower limit of (D₉₀-D₁₀)/D₅₀ is not particularly limited and may be, for example, 0.8 or more.

The cathode active material for a lithium secondary battery according to the present invention may include one-body primary particles of lithium transition metal composite oxide containing at least one of Ni, Co, or Mn, and the average particle size of the primary particles may be 3 to 10 μm.

In one specific embodiment, the lithium transition metal complex oxide may have a composition of Formula 1 below:

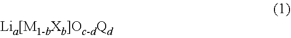

wherein
M is NiₓCo_{y}Mn_{z};
X includes at least one selected from alkali metals excluding lithium, alkaline earth metals, transition metals of Groups 3 to 12 excluding nickel, cobalt and manganese, post-transition metals and metalloids of Groups 13 to 15, and non-metallic elements of Groups 14 to 16;
Q includes at least one of F, P or S;
a, b, c, and d satisfy 0.8≤a≤1.2, 0≤b≤0.3, 1.8<c<2.2, and 0≤d<0.2, respectively,
x, y, and z satisfy 0<x<1, 0<y<1, and 0<<1, respectively, with the proviso of 0<x+y+z≤1.

Specifically, X may, for example, be Na, K, Rb, Cs, or Fr as the alkali metal excluding lithium, may, for example, be Be, Mg, Ca, Sr, Ba, or Ra as the alkaline earth metal, may, for example, be Sc, Ti, V, Cr, Fe, Cu, Zn, Y, Zr, Nb, Mo, Tc, Ru, Rh, Pd, Ag, Cd, Hf, Ta, W, Re, Os, Ir, Pt, Au, or Hg as the transition metal of Groups 3 to 12 excluding nickel, cobalt and manganese, may, for example, be Al, Ga, In, Sn, Tl, Pb, Bi, Po, B, Si, Ge, As, Sb, Te, or At as the post-transition metal or metalloid of Groups 13 to 15, and may, for example, be C, P, S, or Se as the non-metallic element of Groups 14 to 16. The transition metal element may include an element from the lanthanide group or an element from the actinium group. In a preferred embodiment, X may include at least one selected from the group consisting of Zr, Ti, W, B, P, Al, Si, Mg, Zn and V.

The present invention also provides a lithium secondary battery including the cathode active material. The configuration and production method of the lithium secondary battery are known in the art and thus a detailed description thereof will be omitted herein.

### Effects of the Invention

As described above, the cathode active material according to the present invention has excellent particle uniformity and can control fine powder and thus lithium secondary batteries containing the cathode active material have the effects of reducing resistance and improving lifespan characteristics.

### BRIEF DESCRIPTION OF DRAWINGS

FIG. 1 is a graph showing the particle size distributions of cathode active materials according to Comparative Examples 1 and 2, and Examples 1, 2, and 3;

FIG. 2 is a graph showing charge/discharge cycling of cathode active materials according to Comparative Examples 1 and 2, and Examples 1, 2, and 3; and

FIG. 3 is a graph showing the amount of change in DCIR (resistance) during charge/discharge cycling of the cathode active materials according to Comparative Examples 1 and 2, and Examples 1, 2, and 3.

### BEST MODE

Hereinafter, the present invention will be described in more detail with reference to the following examples. These examples should not be construed as limiting the scope of the present invention.

### Preparation Example

NiSO₄ as a nickel precursor, CoSO₄ as a cobalt precursor, and MnSO₄ as a manganese precursor were added to water at a molar ratio of 0.86:0.07:0.07 to prepare a nickel-cobalt-manganese hydroxide precursor aqueous solution. An aqueous solution of sodium hydroxide was slowly added dropwise thereto, while stirring the aqueous solution and the reaction mixture was stirred for 5 hours to neutralize the aqueous precursor solution and precipitate Ni_{0.86}Co_{0.07}Mn_{0.07}(OH)₂, which is nickel-cobalt-manganese hydroxide.

The obtained precursor (nickel cobalt manganese hydroxide) was mixed with LiOH and then heat-treated at 880° C. for 13 hours to prepare Li(Ni_{0.86}Co_{0.07}Mn_{0.07})O₂ particles.

### Example 1

In order to improve the uniformity of the particles, post-treatment was performed by applying a force of about 0.10 MPa to the Li(Ni_{0.86}Co_{0.07}Mn_{0.07})O₂ particles obtained in Preparation Example using a jet mill from NPK to prepare a cathode active material for lithium secondary batteries.

### Example 2

A cathode active material was prepared in the same manner as Example 1, except that a force of 0.15 MPa was applied.

### Example 3

A cathode active material was prepared in the same manner as Example 1, except that a force of 0.2 MPa was applied.

### Comparative Example 1

A cathode active material was prepared in the same manner as Example 1, except that a force of 0.30 MPa was applied.

### Comparative Example 2

A cathode active material was prepared in the same manner as Example 1, except that a force of 0.50 MPa was applied.

### Comparative Example 3

A cathode active material was prepared in the same manner as Example 1, except that no post-treatment was performed.

This experiment (Comparative Example 3) exhibited generation of a very small amount of fine powder as the post-treatment was not performed, but exhibited the poorest particle uniformity. Therefore, the cathode active material of Comparative Example 3 was found to be unsuitable for satisfying the technical object of the present invention to control both the amount of fine powder generated and particle uniformity through appropriate post-treatment and was excluded from evaluation of characteristics in Experimental Example described later.

### Experimental Example 1

The PSD of the cathode active materials for lithium secondary batteries prepared in Examples 1, 2, and 3, and Comparative Examples 1 and 2 were measured, and the particle size distribution graph and particle size distribution obtained by the PSD measurement are shown in FIG. 1 and Table 1.

TABLE 1

| | | | | | | Cumulative relative | | | | | | |
|---|---|---|---|---|---|---|---|---|---|---|---|---|
| | | | | | | particle amount (%) | | | | | | |
| | | | | | | Cumulative | | | | | | |
| | | | | | | relative par- | | | | | Maximum | |
| | Post | | | | | ticle amount | | | (D90- | | height | |
| | treatment | Particle size (μm) | | | | (%) less than | D50 | | D10)/ | | of main | |
| | process | D min | D10 | D50 | D90 | 1.5 μm (a) | (b) | (a)/(b) | D50 | FWHM | peak (h) | FWHM/h |
| Example 1 | 0.10 MPa | 1.50 | 2.69 | 4.56 | 7.04 | 3.26 | 88.18 | 0.04 | 0.95 | 3.86 | 9.69 | 0.40 |
| Example 2 | 0.15 MPa | 1.26 | 2.31 | 3.65 | 5.57 | 12.08 | 86.08 | 0.14 | 0.89 | 3.00 | 10.44 | 0.29 |
| Example 3 | 0.20 MPa | 1.06 | 2.08 | 3.17 | 4.76 | 20.12 | 85.02 | 0.25 | 0.85 | 2.34 | 11.40 | 0.21 |
| Comp. | 0.30 MPa | 0.89 | 1.92 | 2.81 | 4.09 | 31.92 | 84.82 | 0.58 | 0.77 | 1.69 | 12.50 | 0.14 |
| Example 1 | | | | | | | | | | | | |
| Comp. | 0.50 MPa | 0.63 | 1.54 | 2.50 | 3.87 | 56.68 | 89.70 | 1.03 | 0.93 | 1.86 | 10.55 | 0.18 |
| Example 2 | | | | | | | | | | | | |

As can be seen from FIG. 1 and Table 1, as the intensity of the post-treatment process increases, the ratio of the full width at half-maximum (FWHM) of the main peak to the maximum height (FWHM/maximum height) and (D₉₀-D₁₀)/D₅₀ decreases. This can be interpreted that as the intensity of post-treatment increases, particle distribution uniformity also increases.

However, the active materials of Comparative Examples 1 and 2 subjected to excessive post-treatment generated higher amounts of fine powders than Examples 1 to 3 subjected to appropriate post-treatment. The results of particle size distribution (PSD) analysis in Table 1 show that the active materials of Comparative Examples 1 and 2 having a cumulative relative particle amount (%) of particle size of 1.5 μm or less to the relative particle amount (%) of D₅₀ are higher than those of Examples 1 to 3.

In addition, it can be seen that the active materials of Comparative Examples 1 and 2 have relatively low Dmin in particle size distribution (PSD) analysis compared to the active materials of Examples 1 to 3, which indicates that the active materials of Comparative Examples have high possibility of containing fine powder compared to the active materials of Examples.

The result shows that post-treatment for the active materials of Comparative Examples was performed with excessive intensity and thus the particle uniformity was high while the amount of fine powder generated was high. However, unlike Comparative Examples, it can be seen that the particle uniformity and the degree of fine powder generation were controlled within an appropriate range for the active materials of Examples as appropriate intensity of post-treatment was introduced.

### Experimental Example 2

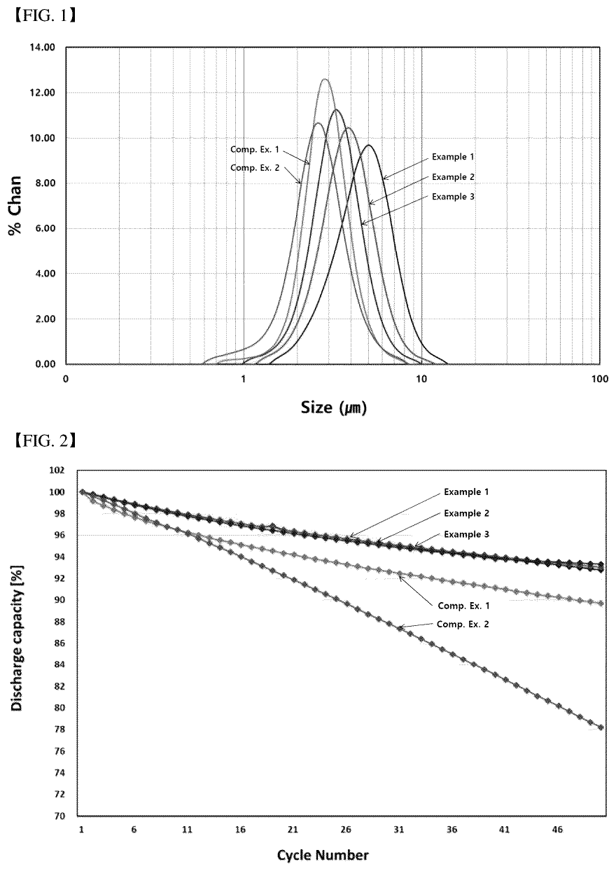

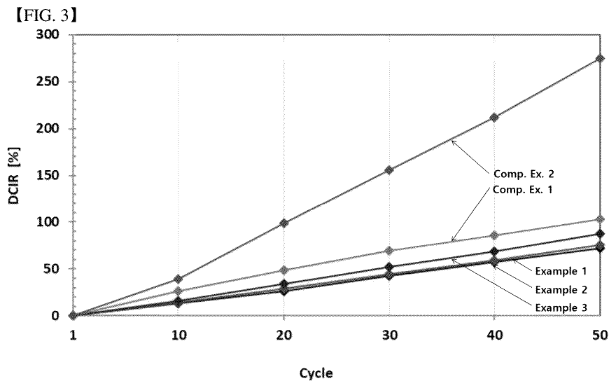

Each of the cathode active materials prepared in Examples 1, 2, and 3, and Comparative Examples 1 and 2 was mixed with a conductive agent and a binder at a ratio of 96:2:2 (active material:conductive agent:binder), and the resulting mixture was applied to an aluminum current collector and then dried to produce a cathode. A secondary battery was manufactured using lithium metal as an anode and EC/DMC/DEC=1/2/1 (vol %)+1M LiPF₆+VC 2 wt % (E2DVC) as an electrolyte and then the electrochemical properties thereof were measured, and the results are shown in Table 2 and FIGS. 2 and 3.

TABLE 2

| | | | | Lifespan/resistance | |
|---|---|---|---|---|---|
| | | | | | Lifespan |
| | 0.1/0.1 FM | | | Lifespan | resistance |
| | Charge | Discharge | Efficiency | 50^{th}/1^{st} | 50^{th}/1^{st} |
| | mAh/g | | % | % | % |
| Example 1 | 227.9 | 202.0 | 88.6 | 92.8 | 71.8 |
| Example 2 | 227.8 | 202.7 | 88.8 | 93.0 | 75.1 |
| Example 3 | 228.2 | 204.9 | 89.0 | 93.3 | 87.4 |
| Comparative | 226.1 | 204.4 | 90.1 | 89.7 | 102.6 |
| Example 1 | | | | | |
| Comparative | 227.0 | 205.7 | 90.6 | 78.2 | 274.6 |
| Example 2 | | | | | |

As can be seen from Table 2 along with FIGS. 2 and 3, the cathode active materials of Examples 1, 2, and 3, and Comparative Examples 1 and 2 do not have significant differences in initial FM capacity, but have noticeable differences in lifespan and lifespan resistance.

Specifically, Comparative Examples 1 and 2 subjected to post-treatment with excessive intensity exhibited high amounts of fine powder generated and thus deteriorated lifespan and lifespan resistance characteristics compared to the active materials of Examples 1 to 3.

Therefore, the present invention provides a cathode active material that exhibits particle uniformity and particle distribution uniformity through introduction of appropriate post-treatment and thus improved battery lifespan and resistance in consideration of the amount of fine powder generated in order to achieve uniform particle distribution.

Although preferred embodiments of the present invention have been disclosed for illustrative purposes, those skilled in the art will appreciate that various modifications, additions and substitutions are possible, without departing from the scope and spirit of the invention as disclosed in the accompanying claims.

1. A cathode active material for a lithium secondary battery comprising one-body primary particles of lithium transition metal complex oxide and having a cumulative relative particle amount (%) of particles having a particle size of 1.5 μm or less, which is 25% or less of a total amount of particles in a particle size distribution (PSD) graph (X-axis: particle size (μm), Y-axis: relative particle amount (%)).

2. The cathode active material according to claim 1, wherein a requirement for the cumulative relative particle amount is determined through a post-treatment process of applying force to active material particles after firing for preparing the cathode active material.

3. The cathode active material according to claim 2, wherein the force applied to active material particles is determined within a range of 0.05 MPa to 0.25 MPa.

4. The cathode active material according to claim 1, wherein a ratio of the cumulative relative particle amount (%) of particles having a size of 1.5 μm or less to the relative particle amount (%) of D₅₀ (cumulative relative particle amount of 1.5 μm or less/relative particle amount of D₅₀) in particle size distribution (PSD) analysis is 0.5 or less.

5. The cathode active material according to claim 1, wherein the cathode active material has a Dmin of 0.9 μm or more in the particle size distribution (PSD) analysis.

6. The cathode active material according to claim 1, wherein the cathode active material has a ratio of a full width at half-maximum (FWHM) of a main peak to a maximum height (FWHM/maximum height) of 1.0 or less on the particle size distribution (PSD) graph.

7. The cathode active material according to claim 1, wherein the cathode active material has a particle size distribution expressed as (D₉₀-D₁₀)/D₅₀ in a range of 1.2 or less.

8. The cathode active material according to claim 1, wherein the transition metal composite oxide comprises at least one of Ni, Co, or Mn.

9. A lithium secondary battery comprising the cathode active material according to claim 1.
